(19) United States
(12) Patent Application Publication
(10) Pub. No.: US 2025/0270145 A1
(43) Pub. Date: Aug. 28, 2025

(54) MANUFACTURING METHOD OF HEAT-INSULATING MATERIAL

(71) Applicant: Sumitomo Riko Company Limited, Aichi (JP)

(72) Inventors: Hiroyuki Ichikawa, Aichi (JP); Yutaro Taguchi, Aichi (JP); Kenji Kimura, Aichi (JP); Yuuki SAITOU, Aichi (JP); Akifumi Miyamoto, Aichi (JP); Hironori Koyama, Aichi (JP); Naho Ito, Aichi (JP); Yoshinori Watanabe, Aichi (JP); Ryusei Yasutomo, Aichi (JP); Hideki Oshima, Aichi (JP)

(73) Assignee: Sumitomo Riko Company Limited, Aichi (JP)

(21) Appl. No.: 19/047,588

(22) Filed: Feb. 6, 2025

(30) Foreign Application Priority Data
Feb. 28, 2024 (JP) 2024-028379

(51) Int. Cl. C04B 35/82; C04B 35/634; C04B 35/64; C04B 38/00

(52) U.S. Cl. CPC C04B 35/82; C04B 35/63488; C04B 35/64; C04B 38/0045; C04B 2235/3418; C04B 2235/3826; C04B 2235/522; C04B 2235/6567; C04B 2235/9607; C04B 2235/9646

(57) ABSTRACT

Provided is a manufacturing method for a heat-insulating material using aerogel. The manufacturing method for the heat-insulating material includes a composition manufacturing process of manufacturing a composition having aerogel and an organic component; a molding process of manufacturing a molded body by pressurizing the composition; and a heat treatment process of holding the obtained molded body at a temperature equal to or higher than a softening point of the organic component.

### CROSS-REFERENCE TO RELATED APPLICATION

This application claims the priority benefits of Japanese application no. 2024-028379, filed on Feb. 28, 2024. The entirety of the above-mentioned patent application is hereby incorporated by reference herein and made a part of this specification.

### BACKGROUND

### Technical Field

The disclosure relates to a manufacturing method of heat-insulating material using aerogel.

### Related Art

Hybrid vehicles and electric vehicles include battery packs that accommodate multiple battery cells. In the battery pack, a laminate of multiple battery cells is accommodated in a housing in a state of being fixed by fastening members from both sides in the lamination direction. Between adjacent battery cells in the lamination direction and other locations, heat-insulating material is placed to suppress heat transfer and prevent thermal runaway in case of abnormal heat generation in the battery cells.

As a material for heat-insulating material, silica aerogel with low thermal conductivity is known. For instance, Japanese Patent Application Laid-Open Publication No. 2021-144879 describes heat-insulating material for battery packs that includes an insulation layer possessing silica aerogel, reinforcing fibers, a thickening agent, and an inorganic binder. Additionally, International Publication No. WO 2023/181443 describes heat-insulating material that includes an insulation layer possessing silica aerogel, infrared shielding particles, inorganic fibers, and organic additives as heat-insulating material with high thermal insulation property even at high temperatures.

### CITATION LIST

### Patent Literature

[Patent Literature 1] Japanese Patent Application Laid-Open Publication No. 2021-144879
[Patent Literature 1] International Publication No. WO 2023/181443
[Patent Literature 1] Japanese Patent Application Laid-Open Publication No. 2011-085216

Battery cells expand and contract in response to charging and discharging. Thus, it is desirable for the heat-insulating material placed between battery cells to possess elasticity that deforms in accordance with the expansion and contraction of the battery cells while maintaining thermal insulation property. More specifically, in the case where battery cells expand due to charging, the heat-insulating material becomes thinner due to the compressive force, and it is necessary to generate a reaction force of a certain value or more to bias the battery cells, thereby avoiding misalignment of the battery cells. Additionally, in the case where battery cells contract due to discharging, it is necessary for the heat-insulating material to restore accordingly and fix the battery cells with a predetermined biasing force. However, in conventional heat-insulating materials, there was an issue that when they repeatedly deform in accordance with the expansion and contraction of the battery cells, the elasticity of the heat-insulating material decreases, resulting in reduced restorability, making it difficult to maintain the desired biasing force against the battery cells.

The disclosure provides a manufacturing method for heat-insulating material that uses aerogel and is less likely to decrease in elasticity even when repeatedly subjected to deformation by compression and releasing.

### SUMMARY

(1) A manufacturing method for a heat-insulating material of the embodiment of the disclosure is a method for manufacturing heat-insulating material which includes aerogel. The method includes a composition manufacturing process of manufacturing a composition having aerogel and an organic component; a molding process of manufacturing a molded body by pressurizing the composition; and a heat treatment process of holding the obtained molded body at a temperature equal to or higher than a softening point of the organic component.

Aerogel is a porous body that forms a skeleton by connecting primary particles of about several nanometers. There are pores of about several nanometers to 100 nanometers between the skeletons, and many of them are mesopores smaller than the mean free path of air. This fine porous structure mainly suppresses conduction and convection among the three forms of heat transfer (conduction, convection, and radiation). Depending on the drying method used in manufacturing aerogel, those dried at atmospheric pressure are sometimes called “xerogel”, those dried under supercritical conditions are called “aerogel,” and those freeze-dried are called “cryogel”. However, in this specification, these are collectively referred to as “aerogel.”

As a manufacturing method for heat-insulating material using aerogel, there is a method of filling aerogel powder or the like into a molding die and pressure-molding it. According to this method, aerogel particles are pressurized, and the voids between aerogel particles are collapsed. Then, when released after molding, the elastic deformation of the aerogel particles may recover or the voids between aerogel particles may widen, causing the molded body to expand (this phenomenon is sometimes referred to as spring-back).

On the other hand, as described in the above-mentioned Patent Literature 1 and 2, organic components may be added to heat-insulating materials as binders to bind constituent components or as dispersants to improve the dispersibility of aerogel. After intensive studies on the elasticity of pressure-molded heat-insulating materials, the inventors of the disclosure obtained the finding that when aerogel powder is pressure-molded together with organic components, the presence of organic components around the aerogel particles hinders the recovery of elastic deformation of aerogel particles after releasing and the recovery of collapsed voids (hereinafter, these may be collectively referred to as “restoration of aerogel particles”).

The manufacturing method for heat-insulating material of the embodiment of the disclosure, based on this finding, includes a heat treatment process that holds a molded body obtained by pressure-molding at a temperature equal to or higher than the softening point of the organic component. In the heat treatment process, the molded body is heated and held at a predetermined temperature to soften, decompose, or vaporize and remove the organic component. As a result, the components that inhibit the restoration of aerogel particles decrease or the restraining force on aerogel particles decreases, making it easier for the inherent elasticity of aerogel to manifest. Consequently, even if the heat-insulating material undergoes repeated deformation, its elasticity is less likely to decrease. Additionally, as the organic component decreases, heat transfer paths through the organic component become less likely to form, which is also effective in improving thermal insulation property. Thus, according to the manufacturing method of the embodiment of the disclosure, it is possible to manufacture heat-insulating material that excels in thermal insulation property and elastic durability.

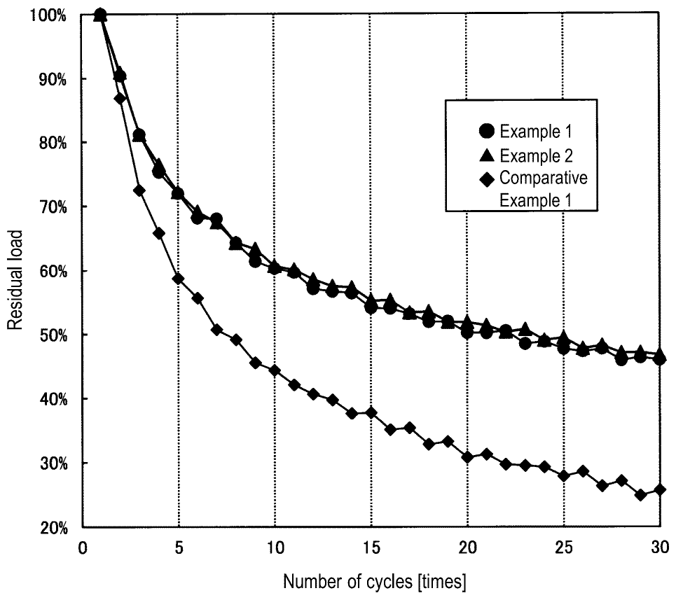

Incidentally, Patent Literature 3 describes a manufacturing method of heat-insulating material by curing a dry pressure-molded body containing silica fine particles and reinforcing fibers at a relative humidity of 70% or higher. However, the heat-insulating material described in this document uses fumed silica instead of aerogel. Thus, this document does not mention the elasticity specific to pressure-molded bodies using aerogel. Moreover, according to paragraphs [0051]-[0054] and FIG. 2 of the same document, high-humidity curing is a process to elute silica from silica fine particles and form a bridging structure between silica fine particles to improve the strength of the heat-insulating material, and there is no mention of any effect on organic components.

(2) In the above configuration, the organic component may be configured as a dispersant for the aerogel. The dispersant is used during the grinding treatment when manufacturing aerogel powder, or when preparing a liquid composition containing aerogel. According to this configuration, it is possible to achieve both improved dispersibility of aerogel by using the dispersant as the organic component and elastic durability of the heat-insulating material.

(3) In the configuration of (2) above, the dispersant may be configured to be at least one type selected from a surfactant and a water-soluble oligomer having both polar and non-polar components in a side chain. According to this configuration, it is possible to easily adjust the viscosity of the composition and the dispersibility of aerogel depending on the type of aerogel or the like.

(4) In the configuration of (3) above, the surfactant may be configured to include sodium carboxymethyl cellulose, polycarboxylic acid amine salt, polycarboxylic acid ammonium salt, polycarboxylic acid sodium salt, TEMPO-oxidized cellulose nanofibers, polyethylene oxide, and polyvinyl alcohol. The surfactants in this configuration are compounds that decompose or vaporize at relatively low temperatures. Thus, according to this configuration, the temperature of the heat treatment process can be set to a relatively low temperature.

(5) In any of the above configurations, the organic component may have polyethylene oxide, and the heat treatment process may be configured to have a temperature of 65° C. or higher and 800° C. or lower. According to this configuration, it is possible to soften or vaporize and eliminate the polyethylene oxide.

(6) In the configuration of (5) above, the heat treatment process may be configured to have a holding time of 30 seconds or longer and 24 hours or shorter. According to this configuration, it is possible to vaporize and eliminate the majority of the polyethylene oxide.

(7) In any of the above configurations, the composition may be further configured to include at least one type selected from an infrared shielding particle and an inorganic fiber.

As mentioned earlier, by using aerogel, it is possible to obtain a high insulation effect mainly by suppressing conduction and convection among the three forms of heat transfer (conduction, convection, and radiation). Here, radiation is a phenomenon in which heat moves by electromagnetic waves, and the higher the temperature, the greater the radiated energy emitted. Thus, in high-temperature environments, radiation becomes the main factor in heat transfer. Consequently, if the heat-insulating material possesses infrared shielding particles that can suppress heat transfer by radiation in addition to aerogel, it is possible to suppress heat transfer by radiation in addition to conduction and convection, realizing high thermal insulation property not only at room temperature but also at high temperatures of 500° C. or higher. Furthermore, in the case where the heat-insulating material possesses inorganic fibers, the mechanical strength of the molded body is enhanced, and it is possible to suppress the detachment of aerogel particles.

(8) In any of the above configurations, the aerogel may be configured to be silica aerogel. Silica aerogel has a good balance between the size of its skeleton and the size of its pores, exhibiting excellent thermal insulation property.

### Effects

According to the manufacturing method of the embodiment of the disclosure, it is possible to manufacture a heat-insulating material using aerogel that is less likely to decrease in elasticity even when repeatedly subjected to deformation by compression and releasing. The heat-insulating material obtained by the manufacturing method of the embodiment of the disclosure, For instance, when placed between battery cells, elastically deforms in response to the expansion and contraction of the battery cells, suppressing misalignment of the battery cells while exhibiting excellent thermal insulation property.

### BRIEF DESCRIPTION OF THE DRAWINGS

The FIGURE shows the change in residual load of heat-insulating material samples in a repeated compression test.

### DESCRIPTION OF THE EMBODIMENTS

(1) A manufacturing method for a heat-insulating material of the embodiment of the disclosure is a method for manufacturing heat-insulating material which includes aerogel. The method includes a composition manufacturing process of manufacturing a composition having aerogel and an organic component; a molding process of manufacturing a molded body by pressurizing the composition; and a heat treatment process of holding the obtained molded body at a temperature equal to or higher than a softening point of the organic component.

Aerogel is a porous body that forms a skeleton by connecting primary particles of about several nanometers. There are pores of about several nanometers to 100 nanometers between the skeletons, and many of them are mesopores smaller than the mean free path of air. This fine porous structure mainly suppresses conduction and convection among the three forms of heat transfer (conduction, convection, and radiation). Depending on the drying method used in manufacturing aerogel, those dried at atmospheric pressure are sometimes called “xerogel”, those dried under supercritical conditions are called “aerogel,” and those freeze-dried are called “cryogel”. However, in this specification, these are collectively referred to as “aerogel.”

As a manufacturing method for heat-insulating material using aerogel, there is a method of filling aerogel powder or the like into a molding die and pressure-molding it. According to this method, aerogel particles are pressurized, and the voids between aerogel particles are collapsed. Then, when released after molding, the elastic deformation of the aerogel particles may recover or the voids between aerogel particles may widen, causing the molded body to expand (this phenomenon is sometimes referred to as spring-back).

On the other hand, as described in the above-mentioned Patent Literature 1 and 2, organic components may be added to heat-insulating materials as binders to bind constituent components or as dispersants to improve the dispersibility of aerogel. After intensive studies on the elasticity of pressure-molded heat-insulating materials, the inventors of the disclosure obtained the finding that when aerogel powder is pressure-molded together with organic components, the presence of organic components around the aerogel particles hinders the recovery of elastic deformation of aerogel particles after releasing and the recovery of collapsed voids (hereinafter, these may be collectively referred to as “restoration of aerogel particles”).

The manufacturing method for heat-insulating material of the embodiment of the disclosure, based on this finding, includes a heat treatment process that holds a molded body obtained by pressure-molding at a temperature equal to or higher than the softening point of the organic component. In the heat treatment process, the molded body is heated and held at a predetermined temperature to soften, decompose, or vaporize and remove the organic component. As a result, the components that inhibit the restoration of aerogel particles decrease or the restraining force on aerogel particles decreases, making it easier for the inherent elasticity of aerogel to manifest. Consequently, even if the heat-insulating material undergoes repeated deformation, its elasticity is less likely to decrease. Additionally, as the organic component decreases, heat transfer paths through the organic component become less likely to form, which is also effective in improving thermal insulation property. Thus, according to the manufacturing method of the embodiment of the disclosure, it is possible to manufacture heat-insulating material that excels in thermal insulation property and elastic durability.

Incidentally, Patent Literature 3 describes a manufacturing method of heat-insulating material by curing a dry pressure-molded body containing silica fine particles and reinforcing fibers at a relative humidity of 70% or higher. However, the heat-insulating material described in this document uses fumed silica instead of aerogel. Thus, this document does not mention the elasticity specific to pressure-molded bodies using aerogel. Moreover, according to paragraphs [0051]-[0054] and FIG. 2 of the same document, high-humidity curing is a process to elute silica from silica fine particles and form a bridging structure between silica fine particles to improve the strength of the heat-insulating material, and there is no mention of any effect on organic components.

(2) In the above configuration, the organic component may be configured as a dispersant for the aerogel. The dispersant is used during the grinding treatment when manufacturing aerogel powder, or when preparing a liquid composition containing aerogel. According to this configuration, it is possible to achieve both improved dispersibility of aerogel by using the dispersant as the organic component and elastic durability of the heat-insulating material.

(3) In the configuration of (2) above, the dispersant may be configured to be at least one type selected from a surfactant and a water-soluble oligomer having both polar and non-polar components in a side chain. According to this configuration, it is possible to easily adjust the viscosity of the composition and the dispersibility of aerogel depending on the type of aerogel or the like.

(4) In the configuration of (3) above, the surfactant may be configured to include sodium carboxymethyl cellulose, polycarboxylic acid amine salt, polycarboxylic acid ammonium salt, polycarboxylic acid sodium salt, TEMPO-oxidized cellulose nanofibers, polyethylene oxide, and polyvinyl alcohol. The surfactants in this configuration are compounds that decompose or vaporize at relatively low temperatures. Thus, according to this configuration, the temperature of the heat treatment process can be set to a relatively low temperature.

(5) In any of the above configurations, the organic component may have polyethylene oxide, and the heat treatment process may be configured to have a temperature of 65° C. or higher and 800° C. or lower. According to this configuration, it is possible to soften or vaporize and eliminate the polyethylene oxide.

(6) In the configuration of (5) above, the heat treatment process may be configured to have a holding time of 30 seconds or longer and 24 hours or shorter. According to this configuration, it is possible to vaporize and eliminate the majority of the polyethylene oxide.

(7) In any of the above configurations, the composition may be further configured to include at least one type selected from an infrared shielding particle and an inorganic fiber.

As mentioned earlier, by using aerogel, it is possible to obtain a high insulation effect mainly by suppressing conduction and convection among the three forms of heat transfer (conduction, convection, and radiation). Here, radiation is a phenomenon in which heat moves by electromagnetic waves, and the higher the temperature, the greater the radiated energy emitted. Thus, in high-temperature environments, radiation becomes the main factor in heat transfer. Consequently, if the heat-insulating material possesses infrared shielding particles that can suppress heat transfer by radiation in addition to aerogel, it is possible to suppress heat transfer by radiation in addition to conduction and convection, realizing high thermal insulation property not only at room temperature but also at high temperatures of 500° C. or higher. Furthermore, in the case where the heat-insulating material possesses inorganic fibers, the mechanical strength of the molded body is enhanced, and it is possible to suppress the detachment of aerogel particles.

(8) In any of the above configurations, the aerogel may be configured to be silica aerogel. Silica aerogel has a good balance between the size of its skeleton and the size of its pores, exhibiting excellent thermal insulation property.

### Effects

According to the manufacturing method of the embodiment of the disclosure, it is possible to manufacture a heat-insulating material using aerogel that is less likely to decrease in elasticity even when repeatedly subjected to deformation by compression and releasing. The heat-insulating material obtained by the manufacturing method of the embodiment of the disclosure, For instance, when placed between battery cells, elastically deforms in response to the expansion and contraction of the battery cells, suppressing misalignment of the battery cells while exhibiting excellent thermal insulation property.

The following describes in detail the manufacturing method of the heat-insulating material of the embodiment of the disclosure. The manufacturing method of the heat-insulating material of the disclosure is not limited to the following forms, and may be implemented in various forms with modifications and improvements that may be made by those skilled in the art within the scope that does not deviate from the essence of the disclosure.

The manufacturing method of the heat-insulating material of the embodiment of the disclosure is a manufacturing method for a heat-insulating material possessing aerogel, and includes a composition manufacturing process, a molding process, and a heat treatment process. The following describes each process.

### Composition Manufacturing Process

This process is a process for manufacturing a composition possessing aerogel and an organic component. The type of aerogel is not particularly limited, and examples of primary particles forming the skeleton include silica, alumina, zirconia, and titania. Among these, from the perspective of excellent chemical stability and ease of obtaining a good balance between the size of the skeleton and the size of the pores, silica aerogel, in which the primary particles are silica, is desirable.

The average particle diameter of the aerogel is desirably 30 μm or more from the perspective of increasing the pore volume and enhancing thermal insulation property. If the particle diameter of the aerogel is small, fine voids are likely to occur between particles, which may cause the molded body to become brittle. A preferable average particle diameter is 50 μm or more. On the other hand, from the perspective of ease of molding into a sheet form and suppression of particle detachment, the average particle diameter is desirably 150 μm or less. A preferable average particle diameter is 120 μm or less. For the average particle diameter of the aerogel powder, the median diameter (D₅₀) obtained from the volume-based particle size distribution measured by laser diffraction and scattering method may be adopted. The aerogel may be used in its manufactured state, or may be further subjected to grinding treatment before use. For the grinding treatment, grinding device such as a jet mill or a spheroidizing treatment device may be used.

From the perspective of achieving the desired thermal insulation property, the content of aerogel in the composition is desirably 65 mass % or more when the solid content of the composition is taken as 100 mass %, and preferably make 70 mass % or more. Here, solid content refers to components excluding volatile substances such as organic solvents and water (the same applies hereinafter).

Examples of organic components include polymers, oligomers, organic compounds, and organic fibers that are added as binders to bind the constituent components of the heat-insulating material, dispersants to improve the dispersibility of aerogel, and thickening agents. The organic component may be one type or two or more types. For instance, as binders, water-based emulsion binders with binder components such as acrylic resin, urethane resin, styrene-butadiene rubber (SBR), nitrile rubber, silicone rubber, urethane rubber, and acrylic rubber may be mentioned. As dispersants for aerogel, surfactants and water-soluble oligomers having both polar and non-polar components in their side chains may be mentioned.

Among these, surfactants include ionic surfactants (cationic surfactants, anionic surfactants, amphoteric surfactants) and non-ionic surfactants. For instance, when using ionic surfactants, it is possible to increase the viscosity of the composition or stabilize the dispersion of materials such as aerogel in the composition even with a relatively small amount. Examples of ionic surfactants include sodium carboxymethyl cellulose (CMC-Na), polycarboxylic acid amine salt, polycarboxylic acid ammonium salt, polycarboxylic acid sodium salt, and TEMPO (2,2,6,6-tetramethylpiperidine 1-oxyl) oxidized cellulose nanofiber (CNF-Na). When using non-ionic surfactants, materials such as aerogel are more easily incorporated into the solvent when preparing the composition. Additionally, when these materials aggregate or separate in the composition, they become easier to re-disperse, or the solvent becomes easier to discharge during pressure-molding. Examples of non-ionic surfactants include polyethylene oxide (PEO) and polyvinyl alcohol (PVA). Among these, PEO has the advantage that the temperature of the subsequent heat treatment may be relatively low because its softening point is at a relatively low temperature.

In the subsequent heat treatment, all of the organic components may disappear due to vaporization, but in some cases, a part may remain without vaporizing, or the organic components may only soften and remain. If organic components remain, there is a risk of forming a heat transfer path through them. Thus, from the perspective of improving thermal insulation property, it is desirable that the content of organic components be 10 mass % or less, and further 5 mass % or less, when the solid content of the composition is 100 mass %. Moreover, whether organic or inorganic, binders do not contribute to improving thermal insulation property. Thus, it is desirable for the composition (molded body) to have a form without binders. In the case of not using binders, it becomes easier to adjust the void volume between aerogel particles and achieve the desired filling state in the molded body manufactured in the subsequent molding process.

The composition may possess other components in addition to aerogel and organic components. The composition may be manufactured by stirring and mixing aerogel, organic components, and other components added as necessary, using a media-less grinding and mixing device, a stirrer, or the like. Other components include, For instance, infrared shielding particles, inorganic fibers, reinforcing inorganic particles, and flame retardants.

Infrared shielding particles contribute to improving thermal insulation property, especially at high temperatures, by absorbing heat from the heat source and re-emitting it from the surface on the heat source side, thereby blocking radiant heat from the heat source. For instance, silicon carbide, kaolinite, silicon nitride, mica, alumina, zirconia, aluminum nitride, zirconium silicate, cerium oxide, boron carbide, manganese oxide, tin oxide, and iron oxide may be mentioned. Inorganic fiber exists physically entangled around the aerogel particles, thereby improving the mechanical strength of the molded body and suppressing the detachment of aerogel particles. For instance, glass fiber and ceramic fibers such as and alumina fiber are preferable. Reinforcing inorganic particles also play a role in improving the mechanical strength of the molded body. For instance, it is preferable to use particles with relatively high hardness and relatively large specific surface area, such as precipitated silica, gel silica, fused silica, wollastonite, potassium titanate, magnesium silicate, glass flakes, calcium carbonate, and barium sulfate. As flame retardants, already known ones such as halogen-based, phosphorus-based, and metal hydroxide-based may be used. Considering the environmental impact, it is desirable to use phosphorus-based flame retardants. Phosphorus-based flame retardants include ammonium polyphosphate, red phosphorus, and phosphoric acid esters. Among these, those that are insoluble in water or coated with water-resistant resin are desirable because the flame retardant is less likely to leach out even when in contact with moisture during use. For instance, ammonium polyphosphate and resin-coated ammonium polyphosphate are suitable.

### <Molding Process>

This process is a process for manufacturing a molded body by pressurizing the composition obtained in the previous process. In this process, the composition may be placed in a mold and pressure-molded, or a slurry-like composition may be applied to a substrate and then pressurized and dried. The molding conditions may be appropriately determined considering the thermal insulation property and elasticity of the resulting molded body. For instance, if the applied load is small and the voids between aerogel particles are large, heat transfer due to air convection may increase, potentially decreasing the thermal insulation property of the molded body. Conversely, if the applied load is large and the voids between aerogel particles are small, the amount of deformation when compressed from the outside may become small. Additionally, there is a risk that excessive compression may crush the aerogel particles. For instance, it is preferable to set the pressure during pressurization to 0.1 MPa or more and 5.0 MPa or less. Pressure-molding may be performed at room temperature or with heating. For instance, in the case of combining drying of the composition, it is preferable to be performed at a temperature of 100° C. or higher and 160° C. or lower. Moreover, since the time required for pressure-molding is relatively short, ranging from several minutes to several tens of minutes, the impact on the organic component is small even when performed under heating.

### <Heat Treatment Process>

This process is a process of holding the molded body obtained in the previous process at a temperature equal to or higher than softening point of the organic component. In the case the molded body contains multiple types of organic components, it is sufficient to hold at a temperature equal to or higher than the lowest softening point among them. To maximize the effect of heat treatment, it is desirable to hold at a temperature equal to or higher than the highest softening point among them. The upper limit of the heating temperature may be determined considering factors such as the shrinkage of the aerogel. For instance, in the case of using silica aerogel, it may be set at 800° C. or lower. In this process, the organic component may soften, decompose, or vaporize and disappear. As a result, the restoration of aerogel particles in the molded body becomes more likely to occur. From the perspective of reducing the restraining force on the aerogel and improving thermal insulation property, it is desirable that at least a part of the organic component disappears due to heating. Moreover, even if the organic components remains, it softens and the restraining force on the aerogel decreases, and it is thought that the distortion of the organic component itself decreases, such that the elasticity of the aerogel becomes more likely to manifest.

The heat treatment may be performed by placing the molded body in an oven or the like. From the perspective of ensuring dimensional accuracy of the molded body, it may be performed while applying a load to the molded body. Humidity adjustment is not particularly necessary, but may be performed in a high humidity environment with, For instance, a relative humidity of 70% or higher. As an example of this process, in the case where polyethylene oxide (PEO) is used as the organic component, it is sufficient to hold at a temperature equal to or higher than its softening point of 65° C. To promote the decomposition and vaporization of PEO, it is preferable to hold at 150° C. or higher, and even more preferably at 200° C. or higher. On the other hand, as long as the heat treatment could be performed within a practical time, there is no need to set an excessively high temperature. Considering factors such as cost, it is preferable to set the heat treatment temperature to 800° C. or lower, more preferably 500° C. or lower, and even more preferably 250° C. or lower. The holding time may be appropriately set according to the heating temperature. For instance, in the case where the organic component is PEO and heating is performed at 65° C. or higher and 800° C. or lower, the holding time may be set to 30 seconds or longer and 24 hours or shorter.

### <Other Processes>

The heat-insulating material obtained by the manufacturing method of the embodiment of the disclosure may be composed solely of the molded body, or may be configured to include a substrate supporting the molded body, an outer packaging material containing the molded body, and so on. In the latter case, the heat-insulating material may be covered with the substrate, using the substrate as the outer packaging material. In the case where the heat-insulating material includes a substrate, outer packaging material, and so on, a substrate lamination process for laminating the molded body and the substrate, or a containment process for containing the molded body in the outer packaging material may be added before or after the heat treatment process. Also, as mentioned earlier, in the molding process, the composition may be applied to the substrate and pressurized together with the substrate.

The materials for the substrate and outer packaging material (hereinafter collectively referred to as “substrate etc.”) include fabric, resin, paper, and so on. The form of the substrate etc. is not particularly limited, and includes woven fabric, non-woven fabric, film, sheet, and so on. The substrate etc. may consist of a single layer or may be a laminate in which two or more layers of the same material or different materials are laminated. For instance, woven fabric or non-woven fabric made from inorganic fibers such as glass fibers or metal fibers, or fire-resistant insulation paper manufactured as a composite material of pulp and magnesium silicate, have relatively low thermal conductivity and high shape retention in high-temperature environments. Among these, glass fiber non-woven fabric, glass cloth, aluminum glass cloth, alkaline earth silicate (AES) wool paper, polyimide fiber non-woven fabric, and so on are highly heat-resistant and particularly suitable.

### Example

Next, the disclosure will be described more specifically by presenting Examples.

### [Manufacturing of Heat-Insulating Material Samples]

### [Composition Manufacturing Process]

69 parts by mass of silica aerogel powder, 20 parts by mass of silicon carbide powder as infrared shielding particles, 8 parts by mass of glass fiber as inorganic fiber, and 3 parts by mass of PEO as a dispersant were added to a stirrer and mixed for 1 minute. While continuing to stir, water was added to achieve a solid content of 40 to 50%. Then, the mixture was further stirred and mixed for 45 minutes to manufacture a clay-like composition.

The details of the materials used are as follows:

Silica aerogel powder: ground product of “Aerogel Particles P200” manufactured by Cabot Corporation, average particle diameter 100 μm.

Silicon carbide powder: “Fuji Random GC #4000” manufactured by Fuji Manufacturing Co., Ltd., average particle diameter 5 μm.

Glass fiber: “Wet Chop” manufactured by Nippon Electric Glass Co., Ltd., length 3 mm, filament diameter 6.5 μm.

PEO: Polyethylene oxide “PEO-8” manufactured by Sumitomo Seika Chemicals Co., Ltd., viscosity average molecular weight 1.7 million to 2.2 million.

### [Molding Process]

The clay-like composition manufactured was pressure-molded as follows. First, a base was prepared by stacking a first spacer plate made of SUS on top of a glass fiber paper. The thickness of the first spacer plate was 7 mm, and a square-shaped injection hole measuring 100 mm on each side was formed in the center. Next, the composition was filled into the injection hole of the first spacer plate and molded into a square plate shape. Then, the first spacer plate was removed, and a separate second spacer plate was placed, followed by stacking a glass fiber paper on top, to manufacture a laminate consisting of “glass fiber paper/composition/second spacer plate/glass fiber paper”. The thickness of the second spacer plate was 6 mm, and similar to the first spacer plate, a square-shaped injection hole measuring 100 mm on each side was formed in the center. The molded composition was contained in the injection hole of the second spacer plate.

Separately, a first board material made of aluminum with a thickness of 5 mm and dimensions of 320 mm square, and a second board material made of aluminum with a thickness of 1 mm and dimensions of 320 mm square were prepared. On one surface of the first board material, multiple grooves were formed. Each of the multiple grooves was linear, with a width of 2.5 mm, a depth of 3 mm, and a length of 200 mm, formed parallel to each other at 5 mm intervals. The second board material had punching holes with a diameter of 1 mm formed throughout at 2 mm intervals. The second board material was stacked on one side of the first board material, and the laminate was placed thereon. Then, the second board material was placed on the laminate, and the first board material was further stacked such that the one surface having the grooves is the second board material side. In this state, pressurized drying by hot pressing was performed for 10 minutes at a temperature of 150° C. and a pressure of 5 MPa, then allowed to cool to room temperature (20° C.±5° C.), and the first board material, second board material, second spacer plate, and upper and lower glass fiber papers were removed to obtain a square plate-shaped molded body with dimensions of 100 mm in length, 100 mm in width, and 6 mm in thickness.

### [Heat Treatment Process]

### (1) Sample of Example 1

The manufactured molded body was placed in an oven and held at 150° C. for 24 hours. After that, it was cooled to room temperature and used as the sample for Example 1.

### (2) Sample of Example 2

The manufactured molded body was placed in an oven and held at 200° C. for 6 hours. After that, it was cooled to room temperature and used as the sample for Example 2.

### Evaluation of Heat-Insulating Material Samples

### [Test Method]

The manufactured samples were placed in a tensile compression tester (Technograph TGI50 kN manufactured by MinebeaMitsumi Inc.) with a set load of 5 kN, and a repeated compression test was performed. The test was conducted by reciprocating the compression terminal at a speed of 1 mm/min, with the upper limit of the compression load set to 10 kN. The interval where the compression load becomes 10 kN→1 kN→5 kN (set load) was defined as one cycle, and this was repeated for 30 cycles. The minimum load was measured for each cycle, and the ratio of the minimum load after each cycle to the load at the time of setting was calculated using the following equation (I). Here, the minimum load refers to the load value when the sample returns to the same thickness as at the time of setting.

$$Residual load ( \% ) = {L}_{n} / {L}_{0} \times 100 \qquad ( I )$$

[L₀: Load at the time of setting (kN), Lₙ: Minimum load after n cycles (kN)]
   In addition, for comparison, a molded body that did not undergo heat treatment was used as a sample for Comparative Example 1, and a repeated compression test was performed in the same manner as the samples of the Examples to determine the residual load.

### [Test Results]

The FIGURE shows a graph illustrating the change in residual load of the heat-insulating material samples in the repeated compression test. As shown in the FIGURE, according to the samples of Examples 1 and 2 that underwent heat treatment, compared to the sample of Comparative Example 1 that did not undergo heat treatment, the decrease in residual load was more gradual, and even after 30 cycles, approximately 50% of the initial (at the time of setting) load remained. Thus, it was confirmed that the manufacturing method of the disclosure makes it possible to manufacture a heat-insulating material whose elasticity does not easily decrease even when deformation caused by compression and releasing is repeated.

### INDUSTRIAL APPLICABILITY

The heat-insulating material manufactured by the manufacturing method of the embodiment of the disclosure may be used for heat-insulating materials for vehicles, heat-insulating materials for housing, heat-insulating materials for electronic devices, heat-insulating materials for heat-retaining and cold-retaining containers, and the like. Among these, it is particularly suitable as a heat-insulating material for battery packs where elasticity is required.

What is claimed is:

1. A manufacturing method for a heat-insulating material having aerogel, the method comprising:
a composition manufacturing process of manufacturing a composition having aerogel and an organic component;
a molding process of manufacturing a molded body by pressurizing the composition; and
a heat treatment process of holding the obtained molded body at a temperature equal to or higher than a softening point of the organic component.

2. The manufacturing method for the heat-insulating material according to claim 1,
wherein the organic component is a dispersant for the aerogel.

3. The manufacturing method for the heat-insulating material according to claim 2,
wherein the dispersant is at least one type selected from a surfactant and a water-soluble oligomer having both polar and non-polar components in a side chain.

4. The manufacturing method for the heat-insulating material according to claim 3,
wherein the surfactant comprises sodium carboxymethyl cellulose, polycarboxylic acid amine salt, polycarboxylic acid ammonium salt, polycarboxylic acid sodium salt, TEMPO-oxidized cellulose nanofibers, polyethylene oxide, and polyvinyl alcohol.

5. The manufacturing method for the heat-insulating material, according to claim 1,
wherein the organic component has polyethylene oxide, and
the heat treatment process has a temperature of 65° C. or higher and 800° C. or lower.

6. The manufacturing method for the heat-insulating material according to claim 5,
wherein the heat treatment process has a holding time of 30 seconds or longer and 24 hours or shorter.

7. The manufacturing method for the heat-insulating material according to claim 1,
wherein the composition further has at least one type selected from an infrared shielding particle and an inorganic fiber.

8. The manufacturing method for the heat-insulating material according to claim 1,
wherein the aerogel is silica aerogel.
